(19) United States
(12) Patent Application Publication
(10) Pub. No.: US 2021/0118018 A1
(43) Pub. Date: Apr. 22, 2021

(54) EVALUATION SYSTEM AND COMPUTER READABLE STORAGE MEDIUM

(71) Applicant: HONDA MOTOR CO.,LTD., Tokyo (JP)

(72) Inventors: Tomohiro SHIBATA, Saitama (JP); Megumi SUNANAGA, Tokyo (JP)

(21) Appl. No.: 17/134,550

(22) Filed: Dec. 28, 2020

Related U.S. Application Data
(63) Continuation of application No. PCT/JP2019/026523, filed on Jul. 3, 2019.

(30) Foreign Application Priority Data
Jul. 4, 2018 (JP) 2018-127320

(51) Int. Cl. G06Q 30/02; B60L 58/12; G07C 5/02; G06Q 50/06; G06Q 20/14

(52) U.S. Cl. CPC G06Q 30/0278; B60L 58/12; G07C 5/02; G06Q 50/30; G06Q 20/145; G06Q 30/0206; B60L 2250/26; G06Q 50/06

(57) ABSTRACT

A system for calculating an equivalent value related to a battery supplying electric energy to a vehicle is provided, including: an acquisition unit for acquiring an input power amount to the battery and an output power amount from the battery; an integrating unit for integrating the input power amount to the battery and the output power amount from the battery; and a calculation unit for calculating an equivalent value related to the battery, based on an integrated value of the input power amount to the battery and the output power amount from the battery.

### CROSS REFERENCE TO RELATED APPLICATION

The contents of the following Japanese patent application and internal application are incorporated herein by reference:

Japanese Patent Application No. 2018-127320 filed on Jul. 4, 2018 and

International Application No. PCT/JP2019/026523 filed on Jul. 3, 2019.

### BACKGROUND

### 1. Technical Field

The present invention relates to an evaluation system and a computer readable storage medium.

### 2. Related Art

A billing system that calculates billing information based on a value obtained by dividing a part or the entire amount of an initial cost of a battery by a predetermined number and the number of charging times of the battery is known (for example, see Patent Document 1 below).

### PRIOR ART DOCUMENTS

### Patent Document

Patent Document 1: Japanese Patent Application Publication No. 2007-108922

### BRIEF DESCRIPTION OF THE DRAWINGS

FIG. 1 schematically illustrates a utilizing environment of a system 10 according to one embodiment.

FIG. 2 schematically illustrates a function configuration of a management server 20.

FIG. 3 illustrates battery usage information stored in a storage unit 280 in a tabulated format.

FIG. 4 illustrates a conceptual diagram for describing a relationship between a usage fee of a battery 32 and prices of a vehicle body and a battery 32 of a vehicle 30.

FIG. 5 illustrates a conceptual diagram for describing the burden on a user at the time of purchasing a vehicle for replacement.

FIG. 6 schematically illustrates one example of a computer 1000 for functioning as the management server 20.

### DESCRIPTION OF EXEMPLARY EMBODIMENTS

Hereinafter, the present invention will be described through embodiments of the invention, but the following embodiments do not limit the invention according to the claims. In addition, not all combinations of the features described in the embodiments are necessarily indispensable to the solution of the invention.

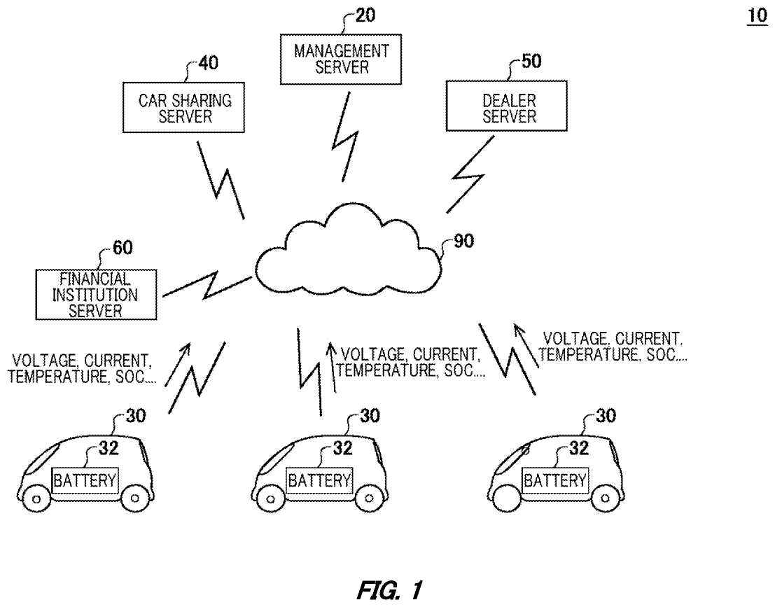

FIG. 1 schematically illustrates a utilizing environment of a system 10 according to one embodiment. The system 10 is a system for calculating the equivalent value of a battery 32 included in a vehicle 30.

A power feeding vehicle deployment system 10 includes a plurality of charging facilities including a management server 20, a plurality of vehicles 30, a car sharing server 40, a dealer server 50, and a financial institution server 60.

The management server 20 is connected to the vehicle 30 via a network 90. The network 90 may be any network. For example, the network 90 may include at least any of the Internet, a mobile phone network such as so-called 3G (3rd Generation), LTE (Long Term Evolution), 4G (4th Generation), and 5G (5th Generation), a public wireless LAN (Local Area Network), and a dedicated network. The vehicle 30 may be wirelessly connected to the network 90. The management server 20 is connected to the car sharing server 40, the dealer server 50 and the financial institution server 60 via the network 90.

The vehicle 30 is an electric motor vehicle. The vehicle 30 stores electric energy supplied from the outside in the battery 32, and drives the wheels using the electric energy stored in the battery 32 to travel. Electric motor vehicles include electric vehicles such as battery electric vehicles (BEVs) and plug-in hybrid electric vehicles (PHEVs). Electric motor vehicles include various vehicles that travel using electric energy, in addition to electric vehicles. For example, the electric motor vehicle may be a straddle-type electric vehicle such as an electric motorcycle.

The vehicle 30 transmits the respective information indicating the voltage and current of the battery 32, the temperature of the battery 32 and so on to the management server 20. The management server 20 calculates and stores an output power amount that is the power amount output from the battery 32 and an input power amount that is the power amount input to the battery 32 based on the information received from the vehicle 30.

The management server 20 integrates the output power amount and the input power amount, and calculates an integrated value of the input/output power amount. For example, when the power amount of 10 kWh is input to the battery 32 by charging the battery 32, and the power amount of 10 kWh is output from the battery 32 due to travelling of the vehicle 30, the management server 20 calculates 20 kWh as the integrated value of the input/output power amount. The management server 20 calculates the equivalent value related to the battery 32 based on the integrated value of the input/output power amount of the battery 32.

For example, in a case where the vehicle 30 is used in the car sharing system, when the vehicle 30 is returned, the car sharing server 40 inquires of the management server 20 about the usage fee of the battery 32. The management server 20 calculates the usage fee of the battery 32 based on the integrated value of the input/output power amount of the battery 32, and then transmits the usage fee to the car sharing server 40. For example, the management server 20 transmits a monetary amount obtained by multiplying the integrated value of the input/output power amount by a predetermined unit price of the usage fee per unit of power amount to the car sharing server 40. The car sharing server 40 bills the user of the vehicle 30 for the received monetary amount from the management server 20 as the usage fee of the battery 32. This enables the user to be billed based on the input/output power amount of the battery 32, so that the user can be billed for an appropriate usage fee with respect to the deterioration degree of the battery 32 according to the charging/discharging amount of the battery 32.

In addition, when the user who owns the vehicle 30 purchases another vehicle for replacement, the management server 20 calculates a buy-up price of the battery 32 based on the integrated value of the input/output power amount and so on of the battery 32, and transmits the buy-up price to the dealer server 50, in response to an inquiry from the dealer server 50. The dealer buys up the battery 32 at the buy-up price received from the management server 20. This enables the buy-up of the battery 32 at an appropriate equivalent value with respect to the battery 32 deteriorated according to the charging/discharging amount of the battery 32.

Also, when the user who owns the vehicle 30 purchases the vehicle 30 at the vehicle body price, the usage fee based on the integrated value of the input/output power amount of the battery 32 may be billed in addition to the installment or the like of the vehicle 30. For example, the financial institution server 60 may acquire the usage fee of the battery 32 based on the integrated value of a monthly input/output power amount of the battery 32, and bill the user by adding the acquired usage fee to the installment.

In this way, according to the management system 10, as the equivalent value of the battery 32 is calculated based on the input/output power amount of the battery 32, thus an appropriate equivalent value can be calculated according to the deterioration degree that changes according to the charging amount to the battery 32 and the discharging amount of the battery 32. This enables a fair billing to the user.

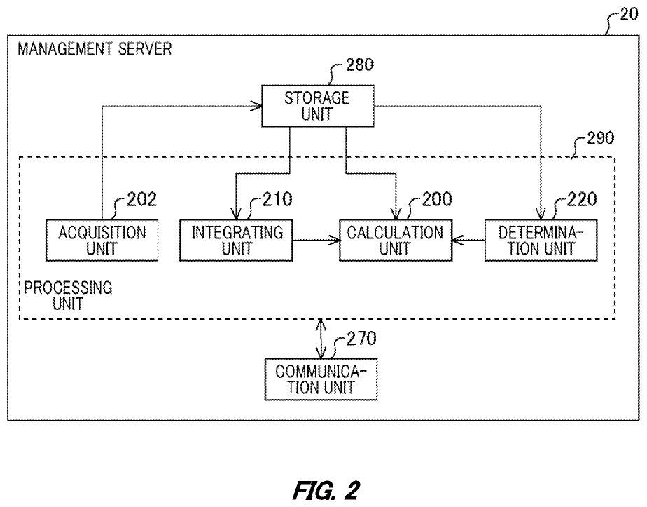

FIG. 2 schematically illustrates a function configuration of the management server 20. The management server 20 includes a processing unit 290, a storage unit 280 and a communication unit 270. The processing unit 290 includes an acquisition unit 202, an integrating unit 210, a determination unit 220 and a calculation unit 200.

The management server 20 is a kind of computer. For example, the processing unit 290 is a processing device such as a microprocessor. The communication unit 270 communicates with the vehicle 30, the car sharing server 40, the dealer server 50 and the financial institution server 60 through the network 90. The information received by the communication unit 270 is supplied to the processing unit 290. The storage unit 280 stores information that is necessary to the operations of the management server 20. For example, the storage unit 280 stores the control programs for the processing unit 290 and the communication unit 270, the constants and variables used by the control programs, and the temporary information that is necessary to the computations of the control programs. The storage unit 280 is one example of the computer readable storage media.

The acquisition unit 202 acquires the information indicating the input power amount that is the power amount input to the battery 32, and the output power amount that is the power amount output from the battery 32. More specifically, the acquisition unit 202 acquires the information indicating the voltage and the current of the battery 32 acquired through the communication unit 270. The acquisition unit 202 stores the input power amount and the output power amount calculated from the voltage and the current of the battery 32 into the storage unit 280.

The integrating unit 210 integrates the input power amount to the battery 32 and the output power amount from the battery 32. The calculation unit 200 calculates the equivalent value related to the battery 32, based on the integrated value of the input power amount to the battery 32 and the output power amount from the battery 32.

For example, the calculation unit 200 calculates the fee billed to the user using the battery 32, based on the integrated value of the input/output power amount. The fee billed to the user may be, for example, the fee billed to the user who utilizes the vehicle 30 in the car sharing system. The fee billed to the user may be, for example, the fee billed to the user who purchases the vehicle 30 at the vehicle body price.

The determination unit 220 determines the deterioration degree of the battery 32. For example, the determination unit 220 may determine the deterioration degree of the battery 32, based on the temperature, SOC of the battery 32, the history of accelerator opening of the vehicle 30 acquired from the vehicle 30.

The calculation unit 200 may calculate the fee, based on the deterioration degree of the battery 32 determined by the determination unit 220 and the integrated value. The calculation unit 200 may calculate the fee so that the higher the deterioration degree of the battery 32 as determined by the determination unit, the higher the ratio of the fee to the integrated value. In this way, the usage fee of the battery 32 with lower deterioration degree may be calculated to be lower.

Note that the calculation unit 200 may calculate the buy-up price of the battery 32 for buying up the vehicle 30 from the user who owns the vehicle 30, based on the integrated value of the input/output power amount. The calculation unit 200 may calculate the buy-up price of the battery 32, based on the deterioration degree of the battery 32 determined by the determination unit 220 and the integrated value.

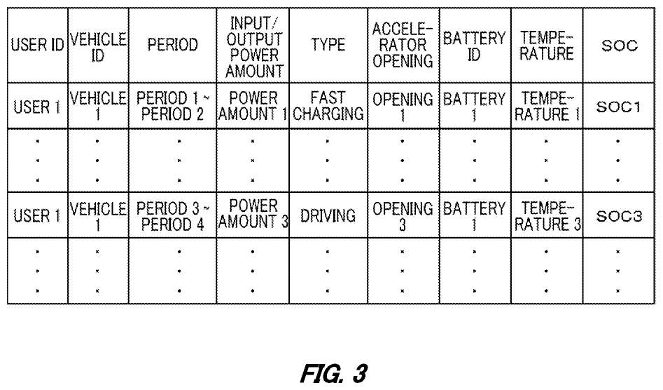

FIG. 3 illustrates the battery usage information stored in a storage unit 280 in a tabulated format. The storage unit 280 includes information of the user ID, the vehicle ID, the period, the input/output power amount of the battery 32, the input/output type, the accelerator opening of the vehicle 30, the battery ID, the temperature of the battery 32, the SOC of the battery 32.

“User ID” is the information for identifying the user who uses the vehicle 30. In the case of the vehicle 30 used in the car sharing system, the car sharing server 40 relates the identification information of the user who uses the vehicle 30 with the identification information of the vehicle 30, and transmits it to the management server 20.

“Vehicle ID” is the information for identifying the vehicle 30. The vehicle ID is assigned to the vehicle 30. “Battery ID” is the information for identifying the battery 32. “Battery ID” is assigned to the battery 32. The vehicle 30 transmits the information such as the voltage, the current, the SOC and the temperature of the battery 32, the accelerator opening of the vehicle 30 and the time in relation with the vehicle ID and the battery ID to the management server 20.

“Period” is the information indicating the period associated with various data stored as the battery usage information. The period may be a variable period of time with any length such as that in seconds, in minutes.

“Input/output power amount” is the information indicating the input power amount to the battery 32, or the output power amount from the battery 32 during the period represented by “period”. The input/output power amount may be calculated based on the battery voltage and the battery current received from the vehicle 30. A positive or negative sign affixed to the battery current may distinguish the input power amount to the battery 32 or the output power amount from the battery 32.

“Type” is the information indicating the type related to the power input/output of the battery 32. For example, the input/output type includes “fast charging”, “normal charging”, “travelling” and so on. The power amount input to the battery 32 during the period of the type of “travelling” indicates the power amount stored in the battery 32 by regenerative energy. The power amount output from the battery 32 during the period of the type of “travelling” indicates the power amount used for the travelling of the vehicle 30.

“Accelerator opening” is the information indicating the amount of accelerator operations by the driver. The accelerator opening is the information corresponding to, for example, the amount of accelerator operation. “Accelerator opening” may be the information indicating the average value or the maximum value of the accelerator opening during the period represented by “period”.

“Temperature” is the information indicating the temperature of the battery 32 measured in the vehicle 30. “Temperature” may be the information indicating the average value of the temperature of the battery 32 during the period represented by “period”.

“SOC” is the information indicating the SOC of the battery 32 calculated in the vehicle 30. “SOC” may be the information indicating the average value of the SOC during the period represented by “period”.

The integrating unit 210 calculates the integrated value of the input/output power amount of the battery 32, by integrating the input/output power amount related with the vehicle ID of the vehicle 30 of the battery usage information. The calculation unit 200 calculates the price of the battery 32 based on the integrated value. For example, the calculation unit 200 calculates the usage fee of the battery 32 in the car sharing system. Also, the calculation unit 200 calculates the buy-up price of the battery 32 at the time of purchasing the vehicle 30 for replacement. Each of the usage fee of the battery 32 and the buy-up price of the battery 32 is one example of the equivalent value for the battery 32.

Note that, the integrating unit 210 may include the input power amount to the battery 32 by the regenerative energy in the integrated value of the input/output power amount for calculating the equivalent value for the battery 32. However, the integrating unit 210 may not include the input power amount to the battery 32 by the regenerative energy in the integrated value of the input/output power amount. For example, the integrating unit 210 may include the input power amount during charging of the battery 32 and the output power amount during travelling of the vehicle 30 in the integrated value of the input/output power amount, and not include the input power amount during travelling of the vehicle 30 in the integrated value.

The determination unit 220 determines the deterioration degree of the battery 32 based on the battery usage information stored in the storage unit 280. For example, when the battery 32 is charged by fast charging, the determination unit 220 may calculate the deterioration degree to be larger compared with the case when the battery 32 is charged by normal charging. Also, the determination unit 220 may calculate the deterioration degree to be larger as the input power amount to the battery 32 by fast charging becomes larger. In this way, the determination unit 220 may determine the deterioration degree based on the charging type indicating fast charging or not, and the input power amount to the battery 32. Also, the determination unit 220 may determine the deterioration degree further based on the SOC during charging. For example, the determination unit 220 may calculate the deterioration degree to be larger as the charging period in the SOC region that is higher than a predetermined reference value becomes longer. According to the determination unit 220, the load on the battery 32 due to the fast charging and so on can be appropriately reflected in the deterioration degree of the battery 32.

Also, the determination unit 220 may calculate the deterioration degree to be larger as the period of the continuous state becomes longer in which the temperature of the battery 32 is higher than the predetermined reference value. For example, the determination unit 220 may calculate the deterioration degree to be larger as the period of the continuous state becomes longer in which the temperature of the battery 32 is higher than the predetermined reference value and the vehicle 30 is not driven. In this way, the load on the battery 32 when, for example, the vehicle 30 is left in a place where sunlight is intense on the vehicle 30, or the battery 32 is left at a high-temperature state, can be reflected appropriately in the deterioration degree.

Also, the determination unit 220 may calculate the deterioration degree to be larger as the accelerator opening becomes larger. The determination unit 220 may calculate the deterioration degree to be larger as the value obtained by multiplying the accelerator opening and the period becomes larger. In this way, the determination unit 220 may determine the deterioration degree based on the accelerator opening and the period. Also, the determination unit 220 may calculate the deterioration degree to be larger as the value obtained by multiplying the accelerator opening and the output power amount becomes larger. In this way, the determination unit 220 may determine the deterioration degree based on the accelerator opening and the output power amount from the battery 32. In this way, the load on the battery 32 due to performing rapid acceleration can be reflected appropriately in the deterioration degree.

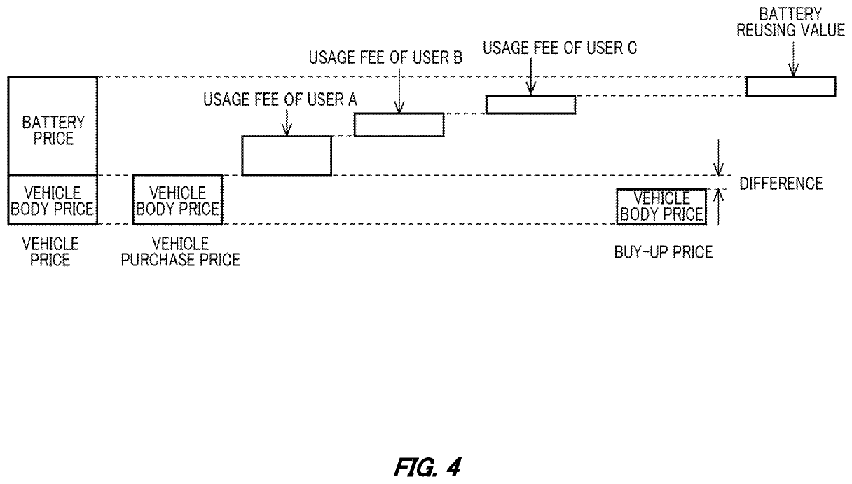

FIG. 4 illustrates a conceptual diagram for describing the relationship between the usage fee of the battery 32 and prices of the vehicle body and the battery 32 of the vehicle 30. The price of the vehicle 30 includes the price of the battery 32 and the vehicle body price other than the battery 32. According to the system 10, for example, the equivalent value corresponding to the price of the battery 32 from the price of the vehicle 30 being utilized for car sharing can be obtained by billing the plurality of users who utilize the vehicle 30.

As shown in FIG. 4, according to the system 10, the price of the battery 32 is paid by a user A, a user B and a user C who have utilized the specific vehicle 30. Each user is billed according to the integrated value of the input/output power amount of the battery 32. For example, when the user A returned the vehicle 30, the car sharing server 40 transmits the information indicating the utilizing period of the vehicle 30 by the user A together with the identification information of the user A to the management server 20, and inquires of the management server 20 about the usage fee of the user A.

The management server 20 calculates the usage fee billed to the user A based on the battery usage information stored in the storage unit 280, according to the request from the car sharing server 40. For example, the integrating unit 210 refers to the battery usage information stored in the storage unit 280, and extracts the input/output power amount corresponding to the identification information of the user A in the period corresponding to the received period information from the car sharing server 40, and then calculates the integrated value of the extracted input/output power amount. Next, the calculation unit 200 calculates the billed usage fee of the user A, by multiplying the integrated value of the input/output power amount by the unit price of the usage fee per unit amount of input/output power.

Certainly, in addition to calculating the usage fee according to the integrated value of the input/output power amount, the calculation unit 200 may also set the usage fee of a constant period or a constant amount of power as a determined price, and then calculate the usage fee of the period or amount of power exceeding the constant period or constant amount of power according to the integrated value of the input/output power amount.

Note that the calculation unit 200 may reduce the usage fee according to the deterioration degree of the battery 32. For example, the determination unit 220 determines the deterioration degree of the battery 32 when the user A started to utilize the vehicle 30. Next, the calculation unit 200 may also calculate the usage fee of the user A by discounting the integrated value of the input/output power amount during a period in which the user A utilized the vehicle 30, and the usage fee based on the unit price of the usage fee per unit amount of input/output power, at a discount rate according to the deterioration degree determined by the determination unit 220. The calculation unit 200 may calculate the usage fee of the user A by applying a larger discount rate as the deterioration degree becomes lower.

As described above, according to the management server 20, each user can be billed according to the deterioration degree of the battery 32 caused by the usage of the vehicle 30 by each user. Therefore, each user can be billed fairly. For example, in general, when the battery 32 deteriorates, the battery capacity decreases or the maximum output decreases, but according to the management server 20, the more the battery 32 of the vehicle 30 used by each user deteriorates, the higher the usage fee becomes, so that the user can be billed only for the value that the user can obtain from the battery 32.

Also, by billing a usage fee by the car sharing system, it is possible to obtain an income corresponding to the price of the battery 32 at the time of purchasing the vehicle from the usage fee obtained from the user. According to the system 10, the usage fee of the battery 32 can be appropriately determined based on the integrated value of the input/output power amount. Therefore, when the total value of the obtained usage fee from all the users who have used the vehicle 30 is lower than the price of the battery 32, it can be considered that the battery 32 is still worth reusing. Therefore, by recovering the battery 32, the value of the battery 32 at the time of purchasing the vehicle can be appropriately recovered.

Accordingly, for example, the operator of the car sharing can purchase the vehicle 30 only at the vehicle body price of the vehicle 30, and the supplier of the vehicle 30 can construct a system to obtain the usage fee of the battery 32 from each user. Also, when the operator of the car sharing has purchased the vehicle 30 at the price including the price of the battery 32 and the vehicle body price, the operator of the car sharing can construct a system to obtain the usage fee of the battery 32 from users, and the reuse fee when the vehicle 30 is sold. In any of the systems, by having the vehicle 30 bought up, the difference between the buy-up price of the vehicle body and the purchase price may be mainly paid.

Note that the billing method of the usage fee of the battery 32 in a car sharing system can also be applied to a vehicle 30 owned by a user. For example, a user who has purchased the vehicle 30 at the vehicle body price may be billed for the usage fee according to the integrated value of the input/output power amount of the battery 32. For example, the financial institution server 60 may acquire the usage fee according to the integrated value of the monthly input/output power amount from the management server 20, and add the usage fee to the installment, and bill the user who owns the vehicle 30. In this way, the billed amount to the user who has rarely used the battery 32 gets lower. Accordingly, the users can be billed fairly according to the used amount of the battery 32.

Note that the billing to the user is not limited only to adding to installment, but may also be billed separately monthly or yearly.

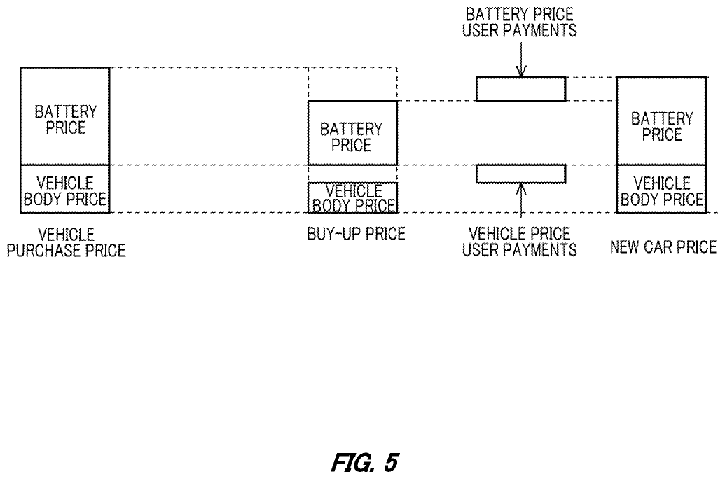

FIG. 5 illustrates a conceptual diagram for describing the burden on a user at the time of purchasing a vehicle for replacement. Herein, the purchase price of the vehicle 30 includes the price of the battery 32 and the vehicle body price. The value of the vehicle body of the vehicle 30 decreases due to the usage of the vehicle 30 of a user, and at the same time, the value of the battery 32 decreases due to the deterioration of the battery 32 such as capacity decrease.

When a user purchases a new vehicle for replacement, the user only pays for the difference between the vehicle body price of the new vehicle and the buy-up price of the vehicle body of the vehicle 30, and the difference between the price of the battery 32 of the new vehicle and the buy-up price of the battery 32 of the vehicle 30.

The buy-up price of the battery 32 may be determined according to the deterioration degree of the battery 32. For example, the dealer server 50 transmits the vehicle ID of the vehicle 30 to the management server 20, and inquires of the management server 20 about the buy-up price of the battery 32. Note that the dealer server 50 may also transmit the battery ID stored in the battery 32 to the management server 20, and inquire of the management server 20 about the buy-up price of the battery 32. The buy-up price is one example of the equivalent value for the battery 32.

In the management server 20, the determination unit 220, as described associated with FIG. 3 and so on, determines the deterioration degree of the battery 32 based on the battery usage information stored in relation with the vehicle ID or the battery ID of the vehicle 30 in the storage unit 280. The calculation unit 200 calculates the buy-up price according to the deterioration degree. For example, when the deterioration degree is calculated to be 40%, 60% of the price of the battery 32 at the time of purchasing the vehicle 30 is calculated as the buy-up price of the battery 32. The buy-up price calculated by the calculation unit 200 is transmitted to the dealer server 50 through the communication unit 270.

In this way, according to the system 10, as the battery 32 can be bought up at an appropriate price according to the remaining capacity of the battery 32, the burden on the user when the user purchases a new vehicle for replacement can be reduced. Note that the system 10 is not limited to only purchasing a new vehicle for replacement, but also can be applied to purchase a used car and so on for replacement. Note that the battery price of a used car may be determined based on the deterioration degree of the battery, the same as the case of determining the buy-up price of the battery 32.

As described above, according to the system 10, according to the integrated value of the input/output power amount of the battery 32 and so on, the appropriate usage fee can be billed to the user who uses the battery 32. Also, according to the deterioration degree regarding the input/output power amount of the battery 32, the appropriate buy-up price of the battery 32 can be determined. In this way, a system that can provide a so-called metered rate billing service to bill the user according to the obtained value from the battery 32 can be constructed.

Note that the billing method according to the integrated value of the input/output power amount in the car sharing system can be applied to a rental car system. The same billing method can be applied to other various forms of vehicle sharing systems using shared vehicles.

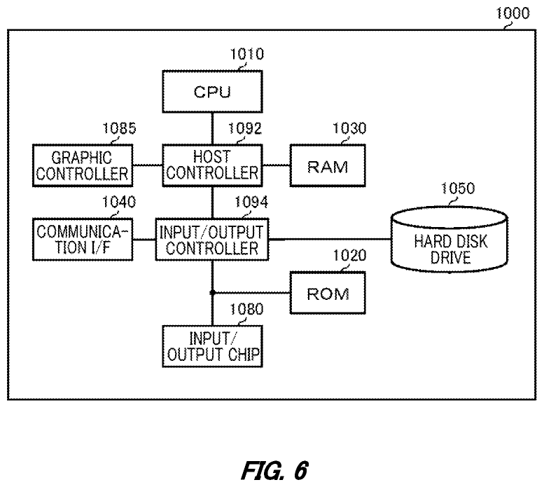

FIG. 6 schematically illustrates one example of a computer 1000 for functioning as the management server 20. The computer 1000 according to this embodiment includes a CPU peripheral unit with a CPU 1010, a RAM 1030 and a graphic controller 1085 that are connected to each other by the host controller 1092, and an input/output unit with a ROM 1020, a communication I/F 1040, a hard disk drive 1050 and a input/output chip 1080 that are connected to the host controller 1092 by the input/output controller 1094.

The CPU 1010 operates based on the programs stored in the ROM 1020 and the RAM 1030, and performs control on each unit. The graphic controller 1085 acquires the image data generated on the frame buffer provided by the CPU 1010 and the like inside the RAM 1030, and presents the image data on a display. Instead of this, the graphic controller 1085 may include the frame buffer therein that stores the image data generated by CPU 1010 and so on.

The communication I/F 1040 communicates with other devices via networks by wire or wireless. Also, the communication I/F 1040 functions as a hardware performing communications. The hard disk drive 1050 stores the programs and data used by the CPU 1010.

The ROM 1020 stores a boot program to be executed when the computer 1000 starts up, a program depending on hardware of the computer 1000, and the like. The input/output chip 1080 connects various input/output devices to the input/output controller 1094 via, for example, a parallel port, a serial port, a keyboard port, a mouse port, and the like.

The program provided to the hard disk drive 1050 via the RAM 1030 is stored in a recording medium such as an IC card and provided by the user. The program is read from the recording medium, installed on the hard disk drive 1050 via the RAM 1030, and executed in the CPU 1010.

Similarly, a program that is installed in the computer 1000 and causes the computer 1000 to function as the management server 20 may work on the CPU 1010 and the like to cause the computer 1000 to function as each unit of the management server 20 including the acquisition unit 202, the integrating unit 210, the calculation unit 200, the determination unit 220, the storage unit 280 and the communication unit 270. The information processing described in these programs is read into the computer 1000 to function as a specific means in which the software and the various hardware resources described above cooperate. By achieving computation or processing of information according to the intended use of the computer 1000 in this embodiment by these specific means, a specific management server 20 corresponding to the intended use is constructed.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: system; 20: server; 30: vehicle; 32: battery; 40: car sharing server; 50: dealer server; 60: financial institution server; 90: network; 202: acquisition unit; 210: integrating unit; 200: calculation unit; 220: determination unit; 270: communication unit; 280: storage unit; 290: processing unit; 1000: computer; 1010: CPU; 1020: ROM; 1030: RAM; 1040: communication I/F; 1050: hard disk drive; 1080: input/output chip; 1085: graphic controller; 1092: host controller; 1094: input/output controller

What is claimed is:

1. A system for calculating an equivalent value related to a battery supplying electric energy to a vehicle, comprising:
an acquisition unit for acquiring an input power amount to the battery and an output power amount from the battery;
an integrating unit for integrating the input power amount to the battery and the output power amount from the battery; and
a calculation unit for calculating the equivalent value related to the battery, based on an integrated value of the input power amount to the battery and the output power amount from the battery.

2. The system according to claim 1, wherein the calculation unit calculates a fee billed to a user who uses the battery, based on the integrated value.

3. The system according to claim 2, further comprising:
a determination unit for determining a deterioration degree of the battery, wherein
the calculation unit calculates the fee, based on the deterioration degree of the battery determined by the determination unit and the integrated value.

4. The system according to claim 3, wherein the calculation unit calculates the fee such that as the deterioration degree of the battery determined by the determination unit becomes higher, the ratio of the fee to the integrated value becomes higher.

5. The system according to claim 1, wherein the calculation unit calculates a buy-up price of the battery when the vehicle is bought up from a user who owns the vehicle, based on the integrated value.

6. The system according to claim 5, further comprising:
a determination unit for determining a deterioration degree of the battery, wherein
the calculation unit calculates the buy-up price of the battery, based on the deterioration degree of the battery determined by the determination unit and the integrated value.

7. The system according to claim 3, wherein
the determination unit determines the deterioration degree of the battery to be higher, as a period of a continuous state becomes longer in which a temperature of the battery is higher than a predetermined reference value and the vehicle is not driven.

8. The system according to claim 4, wherein
the determination unit determines the deterioration degree of the battery to be higher, as a period of a continuous state becomes longer in which a temperature of the battery is higher than a predetermined reference value and the vehicle is not driven.

9. The system according to claim 6, wherein
the determination unit determines the deterioration degree of the battery to be higher, as a period of a continuous state becomes longer in which a temperature of the battery is higher than a predetermined reference value and the vehicle is not driven.

10. The system according to claim 3, wherein
the determination unit determines the deterioration degree of the battery to be higher as an amount of accelerator operations of the vehicle by a driver of the vehicle becomes larger.

11. The system according to claim 4, wherein
the determination unit determines the deterioration degree of the battery to be higher as an amount of accelerator operations of the vehicle by a driver of the vehicle becomes larger.

12. The system according to claim 6, wherein
the determination unit determines the deterioration degree of the battery to be higher as an amount of accelerator operations of the vehicle by a driver of the vehicle becomes larger.

13. The system according to claim 7, wherein
the determination unit determines the deterioration degree of the battery to be higher as an amount of accelerator operations of the vehicle by a driver of the vehicle becomes larger.

14. The system according to claim 8, wherein
the determination unit determines the deterioration degree of the battery to be higher as an amount of accelerator operations of the vehicle by a driver of the vehicle becomes larger.

15. The system according to claim 9, wherein
the determination unit determines the deterioration degree of the battery to be higher as an amount of accelerator operations of the vehicle by a driver of the vehicle becomes larger.

16. The system according to claim 1, wherein the integrating unit does not integrate a power amount input to the battery during travelling of the vehicle.

17. The system according to claim 2, wherein
the integrating unit does not integrate a power amount input to the battery during travelling of the vehicle.

18. The system according to claim 3, wherein
the integrating unit does not integrate a power amount input to the battery during travelling of the vehicle.

19. The system according to claim 1, further comprising the vehicle.

20. A non-transitory computer readable storage medium having stored thereon a program for calculating an equivalent value related to a battery supplying electric energy to a vehicle, wherein the program causes a computer to function as:
an acquisition unit for acquiring an input power amount to the battery and an output power amount from the battery;
an integrating unit for integrating the input power amount to the battery and the output power amount from the battery; and
a calculation unit for calculating an equivalent value related to the battery, based on an integrated value of the input power amount to the battery and the output power amount from the battery.
